(19) United States
(12) Patent Application Publication
(10) Pub. No.: US 2019/0232184 A1
(43) Pub. Date: Aug. 1, 2019

(54) Modular Electronics System

(71) Applicant: Patently Good Pty Ltd, Brisbane City (AU)

(72) Inventor: Mario Alexander Marin Agudelo, Carindale (AU)

(21) Appl. No.: 16/311,197

(22) PCT Filed: Jun. 23, 2016
(86) PCT No.: PCT/AU2016/050528

§ 371 Date: Dec. 19, 2018

(30) Foreign Application Priority Data
Jun. 25, 2015 (AU) 2015902467

(51) Int. Cl. A63H 33/04; A63H 33/06; G09B 5/00

(52) U.S. Cl. CPC A63H 33/042; A63H 2200/00; G09B 5/00; A63H 33/06

(57) ABSTRACT

A modular electronics system including at least one node including a plurality of interconnected modules. The modules are physically and electrically interconnected, with different modules providing respective functionality, typically including communications, sensing of conditions and performing actions. A hub is provided that communicates with the nodes, determines at least one action to be performed at least partially in accordance with the sensed conditions causes the at least one action to be performed.

### BACKGROUND OF THE INVENTION

The present invention relates to a modular electronics system, and in one particular to a modular electronics system that allows a number of different modules to be combined to allow a range of different functionality to provided.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Unlike software development, building electronic devices requires the use of specialised tools and intermediate to advanced levels of equally specialised knowledge and skills. This is a real problem as it excludes those with new ideas who do not have the knowledge and skills to create. Additionally, testing and prototyping requires countless hours of trial and error. If an individual wishes to test a different idea, they need to dismantle a current prototype and build a new one. If the new assembly doesn't behave as well as the previous one, it is necessary to repeat the same process and go back to the previous build.

It is known to provide modular electronics systems. One example of this is Lego's Mindstorm™ system, which as described in U.S. Pat. No. 7,708,615, includes a toy building system with function bricks adapted to perform a function in response to a mechanical trigger action; sensor bricks with a sensor adapted to produce an output in response to a mechanical trigger action; and logic bricks with an input responsive to a sensor brick output and adapted to perform a logic function on the sensor brick output and to produce a logic output. The sensor brick output and the logic brick output are arranged in a first uniform manner relative to the coupling means, and the sensor output action and the logic output action are of uniform physical nature. The logic brick input and the function brick input are arranged in a second uniform manner relative to the coupling means. The function brick input is responsive to a logic brick output and adapted to perform the function in response to a logic brick output.

However, this suffers from the disadvantage of requiring physical interconnection to a control system for control and limited functionality.

In the case of LittleBits™, this system uses independent magnetically interconnected modules, these provide only limited functionality and require physically interconnected blocks. Furthermore, operation of the blocks can only be adapted using complex programming, which in turn limits access to additional functionality to skilled programmers.

It is therefore apparent that there is need for a system that can provide a wide range of functionality in a manner that is easy for individuals with little skill or expertise to use.

### SUMMARY OF THE PRESENT INVENTION

In one broad form the present invention seeks to provide a modular electronics system including:
a) at least one node including a plurality of interconnected modules, each module including:
   i) a housing;
   ii) physical connectors that physically interconnect the modules;
   iii) electrical connectors that electrically interconnect the modules, the electrical connectors including data and power connectors; and,
   iv) electronic components that provide respective functionality, wherein each node includes:
      (1) at least one communications module; and,
      (2) at least one of:
         (a) a sensor module including at least one sensor that generates sensor data indicative of one or more sensed conditions; and,
         (b) an action module that performs one or more actions in accordance with received control data; and,
b) a hub including:
   i) a module interface that communicates with the at least one communications module of each node;
   ii) a hub processor that, in accordance with defined instructions:
      (1) monitors sensor data provided by at least one sensor module;
      (2) determines at least one action to be performed at least partially in accordance with the sensor data; and,
      (3) causes the at least one action to be performed by at least one of:
         (a) at least one action module; and,
         (b) an external device.

Typically the instructions define module logic defining how modules interact, and wherein the hub determines actions in accordance with the module logic.

Typically the instructions define actions associated with defined sensor readings, and wherein the hub processor:
a) compares sensor data from a respective sensor module to defined sensor readings; and,
b) determines the actions at least in part in accordance with the results of the comparison.

Typically the hub processor:
a) receives sensor data from a respective sensor module; and,
b) stores the sensor data in a data store together with an indication of the respective sensor module.

Typically the hub processor:
a) determines sensor data required from a respective sensor module using the instructions;
b) determines if sensor data from the respective sensor module is received within a defined time period; and,
c) if sensor data is not received during the defined time period, retrieves sensor data from the data store.

Typically the hub processor:
a) determines the actions to be performed at least in part using the instructions;
b) generates control data in accordance with the actions to be performed; and,
c) transfers the control data, to at least one of:
   i) at least one action module; and,
   ii) an external device.

Typically the hub includes a hub memory that stores a program defining the instructions.

Typically the hub processor at least one of:
a) performs instructions received from a client device;
b) performs instructions defined by a program stored in memory; and,
c) performs multiple sets of instructions substantially simultaneously.

Typically the hub processor:
a) provides a module request to each node;
b) receives an indication of modules within each node in response to the module request; and,
c) maintains a list of available modules in accordance with received indications of modules.

Typically the communications module:
a) receives the module request;
b) broadcasts the module request to each module within the node;
c) receives a module response from each module; and,
d) provides an indication of modules to the hub in accordance with the module responses.

Typically at least some of the modules include a module processor that communicates with the hub via the communications module.

Typically at least some of the modules include a module memory that stores module settings, the module operating in accordance with module settings.

Typically the module settings include at least one of:
a) sleep settings;
b) communication settings;
c) address settings;
d) a sensor sampling frequency;
e) status settings; and,
f) actuator settings.

Typically each communications module is associated with a respective node address and wherein the hub communicates with the node using the respective node address.

Typically each module within a node is associated with a respective module address and wherein the hub and modules within a node communicate using the respective module address.

Typically each node includes at least one power module that supplies electrical power to other modules in the node.

Typically the action module includes at least one of:
a) an output device that generates an output;
b) a display that displays visual information;
c) a switch that actuates an external device; and,
d) an actuator that performs a defined actuation.

Typically at least one sensor module includes at least one of:
a) an accelerometer;
b) a light sensor;
c) a microphone;
d) a temperature sensor; and,
e) an input device that senses user inputs.

Typically at least one communications module includes a wireless communications module.

Typically the system includes a client device having:
a) a display;
b) an input device;
c) a memory storing applications software; and,
d) an electronic processing device that operates in accordance with the applications software to:
   i) determine a module logic corresponding to interaction between selected ones of the modules in accordance with user input commands;
   ii) generate instructions in accordance with the module logic; and,
   iii) provide the instructions to the hub, the hub responsive to the instructions to control the modules.

Typically the system includes a client device having:
a) communicate with the hub to determine available modules, the available modules forming part of nodes in communication with the hub; and,
b) display an indication of available modules.

Typically the client device:
a) determines module settings for at least one module in accordance with user input commands; and,
b) provides an indication of the module settings to the hub, the hub being responsive to the indication to update module settings associated with the at least one module.

Typically the client device:
a) determines actions to be performed by external devices in accordance with user input commands; and,
b) generates the instructions in accordance with the actions.

Typically the client device:
a) displays an interface including icons representing available modules, each icon representing a corresponding module;
b) positions icons on the interface in accordance with user input commands;
c) displays connections between the icons in accordance with user input commands; and,
d) generates the instructions at least in part based on the connections between the icons.

Typically the client device:
a) determines a user selected icon in accordance with user input commands;
b) determines module settings associated with the corresponding module;
c) displays an indication of the module settings;
d) determines modified module settings in accordance with user input commands; and,
e) provides an indication of the modified module settings to the hub, the hub being response to update module settings for the corresponding module.

Typically the client device:
a) generates a program including the instructions; and,
b) provides the program to at least one of:
   i) the hub; and,
   ii) a data store.

Typically the client device:
a) communicates with a data store to determine available programs;
b) displays an indication of available programs;
c) determines a selected program in accordance with user input commands;
d) compares available modules to a list of module requirements associated with the selected program;
e) determines if any module requirements are not met; and,
f) provides an indication of any unmet module requirements to the user.

Typically the physical connectors include magnets.

In one broad form the present invention seeks to provide a client device for controlling a modular electronics system, the modular electronics system having at least one node including a plurality of interconnected modules and a hub that communicates with the modules, the client device having:
a) a display;
b) an input device;
c) a memory storing applications software; and,
d) an electronic processing device that operates in accordance with the applications software to:
   i) communicate with the hub to determine available modules, the available modules forming part of nodes in communication with the hub;
   ii) display an indication of available modules;
   iii) determine a module logic corresponding to interaction between selected ones of the modules in accordance with user input commands, at least one of:
   iv) generate instructions in accordance with the module logic; and,
   v) provide the instructions to the hub, the hub responsive to the instructions to control the modules.

### BRIEF DESCRIPTION OF THE DRAWINGS

An example of the present invention will now be described with reference to the accompanying drawings, in which:

FIG. 1 is a schematic diagram of an example of a modular electronics system;

FIG. 2A is a schematic plan view of an example of a module of FIG. 1;

FIG. 2B is a schematic side view of the module of FIG. 2A;

FIG. 2C is a schematic side view of multiple modules of FIG. 2A in a stacked arrangement;

FIG. 2D is a schematic plan view of an alternative example of a module of FIG. 1;

FIG. 2E is a schematic side view of multiple modules of FIG. 2D in a stacked arrangement;

FIG. 3 is a flow chart of an example of the operation of the modular electronics system of FIG. 1;

FIG. 4 is a flow chart of an example of a process for generating instructions for the modular electronics system of FIG. 1;

FIG. 5 is a schematic diagram of a second example of a modular electronics system;

FIG. 6 is a schematic diagram of an example of a server of FIG. 5;

FIG. 7 is a schematic diagram of an example of a client device of FIG. 5;

FIGS. 8A to 8C are a flow chart of an example of the process for generating instructions for the modular electronics system of FIG. 5;

FIGS. 9A to 9C are examples of the user interface displayed by the client device of FIG. 5;

FIG. 10 is a flow chart of an example of a process for obtaining an application; and,

FIGS. 11A and 11B are a flow chart of an example of operating the modular electronics system of FIG. 5.

### DETAILED DESCRIPTION OF THE PREFERRED EMBODIMENTS

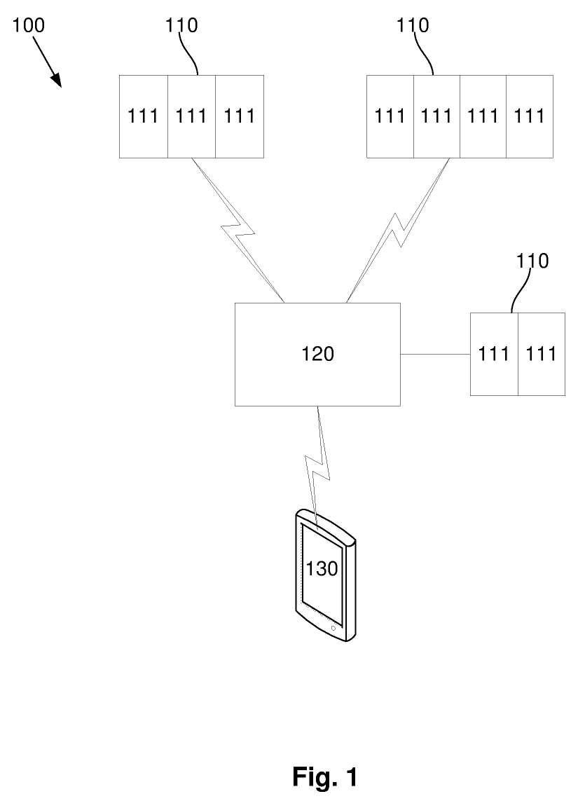

An example of a modular electronics system will now be described with reference to FIG. 1.

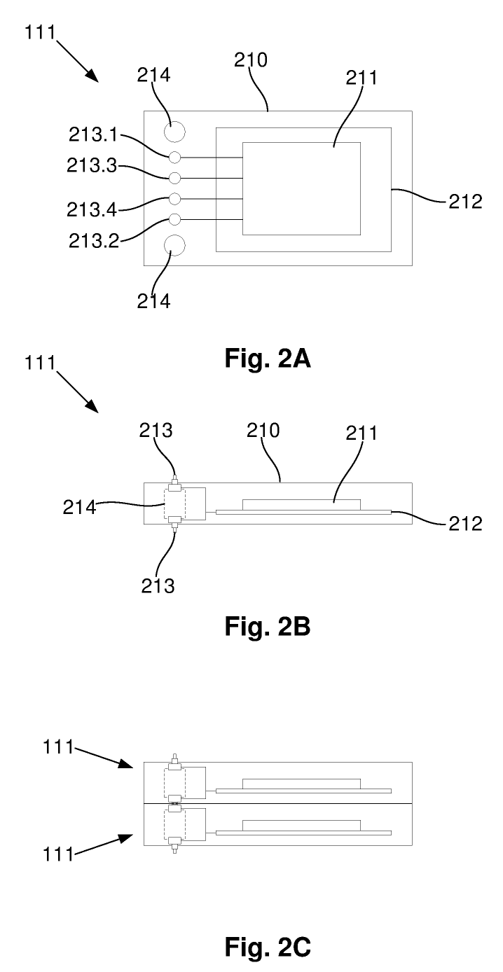

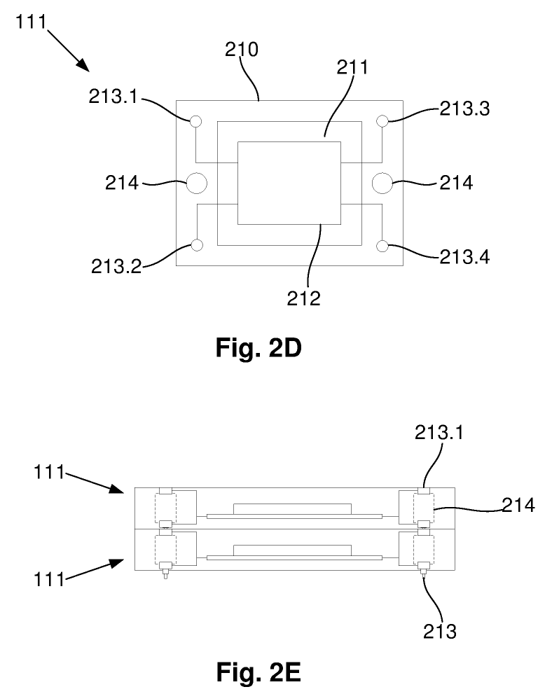

In this example, the modular electronics system includes at least one node 110, with three nodes being shown in this example for the purpose of illustration only. Each node 110 includes a plurality of interconnected modules 111, examples of which are shown in more detail in FIGS. 2A to 2C.

As shown, each module 111 includes a housing 210 containing physical connectors 214 that are used to physically interconnect the modules. In a preferred example the physical connectors are magnets, which are used to magnetically connect the modules, although this is not essential and other connection mechanisms could be used, such as having complimentary shaped housings that couple via friction or interference fits, the use of fasteners, such as clips or screws, or the like. The housing 210 further includes electrical connectors 213.1, 213.2, 213.3, 213.4, which electrically interconnect the modules, with the connectors including data and power connectors.

In one particular example, the connectors 213.1, 213.2, 213.3, 213.4 and magnets 214 are provided in a generally linear arrangement so that the magnets couple the housings 210 of adjacent modules together so that the connectors 213.1, 213.2, 213.3, 213.4 are aligned, and hence abut connectors on the other housing. However, this is not essential and any suitable configuration could be used. For example, the connectors could be positioned adjacent respective corners of the module, with the magnets being provided adjacent opposing edges, as shown in FIG. 2D. It will be appreciated from this that a wide range of configurations could be used, the examples shown are for the purpose of illustration only.

The connectors are biased connectors, such as spring-mounted connectors, which are depressed upon engagement of the module housings 210 so as to ensure good electrical connectivity. Sets of connectors 213.1, 213.2, 213.3, 213.4 can be provided on opposing faces of the module housing 210 allowing multiple modules 111 to be stacked together. It will also be appreciated however that biased connectors 213 could be provided on one side of the housing only, with a flat contact pad 213.1 being provided on the opposing side, thereby simplifying the connector arrangement. Again any other suitable connector arrangement could be used.

The housing 210 further includes one or more electronic components that may be mounted on an appropriate circuit board 212 such as a PCB board or the like, as will be described in more detail below. The electrical components provide respective functionality to the modules with a range of different modules being provided depending upon the preferred implementation and are coupled to the connectors 213.1, 213.2, 213.3, 213.4, thereby allowing power and data to be transferred to the components.

The components included within the module will vary depending on the intended functionality, although generally, each module will include basic common components, such as a memory and basic processor, allowing basic operations to be performed, such as routing of data. Additionally, the module can include components specific to a particular functionality, such as sensors, actuators, or the like as will be described in more detail below.

In general, each node 110 includes at least one communications module 111 and one or more of a sensor module 111, including at least one sensor that generates sensor data indicative of one or more sensed conditions, or an action module that performs one or more actions in accordance with received control data.

The communications module is typically configured to allow for communications with a hub 130. The communications module is typically adapted to communicate with the hub wirelessly, for example using a wireless communications protocol, such as WiFi, BLE, 2.4 GHz or 5 Ghz radio, or the like. However, this is not intended to be limiting and in some applications, such as those requiring security, low power requirements, or high bandwidth, wired protocols can be used to increase reliability, bandwidth, security and to allow for power to be supplied to the node.

The nature of the sensor modules and the corresponding sensor data will vary depending upon the preferred implementation and the particular sensor modules selected by a user. In this regard, a wide range of different sensors could be available, with users incorporating selected ones of these into nodes, depending on functionality they require the system to perform. Example sensors include proximity sensors, accelerometers, light sensors, temperature sensors, humidity sensors, smoke sensors, or the like. Additionally, the sensors could provide input functionality, such as input buttons or the like, allowing the modules to sense user input. It will therefore be appreciated that the term sensor is intended to cover any form of input that can be detected in some manner, and is not intended to be limiting.

Similarly, the action modules and the associated actions that can be performed will also vary depending upon the preferred implementation and could include activating indicators, displays or other outputs, allowing information to be communicated to users nor other individuals, controlling physical devices, such as household appliances, for example by providing output signals such as infrared remote control signals, or activating power supply to devices, as well as controlling physical actuators, such as servo motors, or the like. The action modules could also perform actions that are used internally within the system, and not necessarily provided as an output, such as timers used for measuring time periods used in controlling further operations or the like. It will be appreciated however that these examples are illustrative only, and again are not intended to be limiting. Consequently, the term action module will be understood to encompass any form of action that could be performed by a module.

Additional types of modules may also be provided, such as power modules for providing power to the other modules and further examples will be described in more detail below.

The apparatus further includes a hub 120, which operates to interact with the nodes allowing the modules therein to be controlled. The hub 120 typically includes at least a module interface 121 and a hub processor 122. The module interface 121 is used to allow the hub to communicate with the communications module of each node, and can be of any suitable form, such as a short range wireless interface, wired network connection, such as an Ethernet connection, or the like. Additionally, in some scenarios, nodes can be coupled directly to the hub, without requiring a communications module, for example if the ability to provide communications is inbuilt into another module, such as a sensor module.

The hub processor 122 operates to control operation of the modules, as will be described in more detail below, and can be any suitable form of processor, such as a microprocessor, microchip processor, logic gate configuration, firmware optionally associated with implementing logic such as an FPGA (Field Programmable Gate Array), or any other electronic device, system or arrangement.

A client device 130, such as a suitably programmed computer system, or mobile communications device, such as a tablet or smartphone, may also be provided in communication with the hub 120, with the client device 130 being utilised in order to control the hub and provide instructions to the hub, as will be described below.

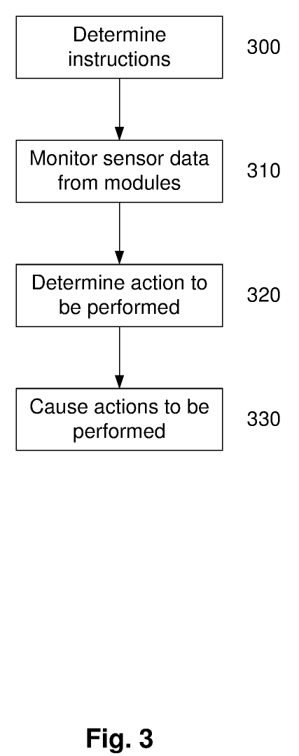

Operation of the hub 120 to control the modular electronics system will now be described with reference to FIG. 3.

In this example, at step 300 the hub processor 122 determines defined instructions. The instructions can be determined in any one of a number of manners and could be received from the client device 130, for example as a sequence of commands, or alternatively could be retrieved from a data store, such as an internal memory, remote database, or the like, depending on the preferred implementation. The instructions define how the hub 120 should interact with the modules 111, and could be in the form of an application executed by the hub processor 122, or a simply commands that the hub processor implements, depending on the preferred implementation.

At step 310, the hub processor 122 monitors sensor data provided by one or more sensor modules, and uses the sensor data and the instructions to determine at least one action to be performed at step 320. Thus, for example, the instructions could define the sensor modules that should be monitored by the hub processor 122, and how received sensor data should be interpreted to determine the actions that are to be performed. By way of illustration, this could include comparing sensor readings to defined readings, and performing a specified action once a particular sensor reading occurs.

At step 330, the hub processor 122 causes the respective action to be performed either utilising at least one action module of a node and/or by communicating with an external device, such as the client device 130 or a remote server, allowing the action to be performed remotely. In this regard, some actions, such as sending an email or SMS may not be readily performed by specific action modules, and instead are more appropriately performed by a remote device, such as a computer system. In this case, the remote device can act as a “virtual” action module, with the instructions defining how the hub should communicate with the remote device, allowing the necessary action to be performed.

Accordingly, the above-described modular electronics system allows a wide range of functionality to be implemented by allowing users to provide nodes including combinations of different modules, typically including one or more sensor and/or action modules. Operation of the system is controlled via a hub, which receives sensor data from sensor modules and then interprets this using defined instructions, allowing corresponding actions depending on the received sensor data.

The above-described arrangement has a number of particular benefits. For example, nodes can be constructed including a wide range of sensor, action or other modules, providing a high degree of flexibility in terms of the functionality that can be delivered by the system. In this regard, the modules can be easily interconnected utilising magnets so that electrical connectors on the modules are aligned, allowing modules to be connected in various combinations so as to function as a consolidated node, whilst enabling modules to be easily integrated into and removed from nodes as required.

Operation of the nodes and hence the modules is coordinated by a central hub in wireless communication with the nodes, meaning that nodes can be physically separated, whilst allowing these to be controlled in a coordinated manner. As a result, functionality can be easily distributed across physically separate nodes so that, for example, a sensor on a first node can be used to cause an action to be performed by an action module on a physically separate second node. This allows a wide range of functionality to be achieved, and also allows the system to be inherently scalable, as a large number of modules can be provided in each node and a large number of nodes coordinated by a single hub.

In addition to this, by allowing the hub processor to interpret sensor data and control action modules using defined instructions, this allows a high degree of control to be provided, without requiring each module to be individually programmed. Additionally, this allows individual modules to be used as part of multiple different processes substantially simultaneously. For example, this allows multiple sets of instructions to be implemented by the hub in parallel, so that a single sensor or action module could be re-used in multiple different processes executed simultaneously, thereby vastly reducing the hardware requirements compared need to implement functionality as compared to existing systems.

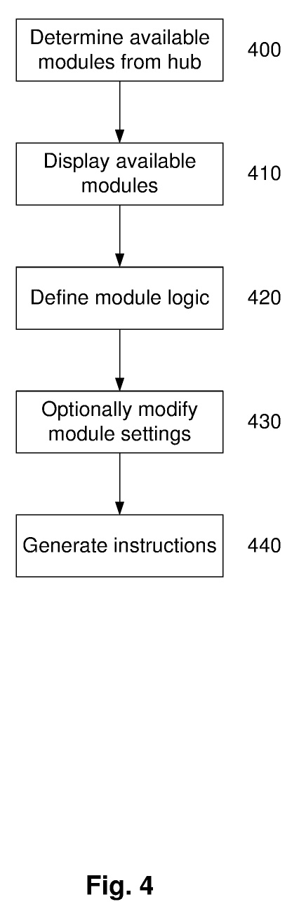

The instructions implemented by the hub can be created by a client device 130 and provided to the hub, either for implementation in real-time, or allowing for storage and subsequent execution on demand. In one example, this is performed at least in part using a graphical interface displayed on the client device, allowing users to create their own instructions in an intuitive manner, avoiding the need for specialised programming skills. An example of this process will now be described with reference to FIG. 4.

In this example, at step 400, the client device 130 determines available modules from the hub 120. This can be achieved in any appropriate manner but typically involves having the hub poll the nodes to determine available modules within the nodes and then provide an indication of this information to the client device 130.

At step 410, the client device 130 displays available modules to the user allowing the user to define a module logic corresponding to interaction between selected ones of the modules at step 420. This could be achieved in any appropriate manner, but in one example involves displaying icons representing individual modules, with the user arranging the icons and optionally providing connections between the icons, so as to define interactions between the corresponding modules. For example, this could include connecting a sensor module output to an action module input, so that an action is performed by the action module based on sensor data generated by the sensor module.

As part of this process, at step 430 the user can optionally modify module settings associated with each module. The module settings can be utilized in order to control certain aspects of module behaviour, such as an operating mode, sampling rate of a sensor, or the like, as will be described in more detail below.

At step 440 the client device 130 generates instructions, which can then be provided to the hub 120, the hub 120 being responsive to the instructions to control the modules. The instructions could be in the form of a set of commands, allowing these to be implemented by the hub upon receipt, or alternatively could be in the form of an application executed by the hub as required.

Accordingly, it will be appreciated that this provides a logical and intuitive mechanism to create instructions, allowing the hub to control operation of the modules, and hence enabling desired functionality to be implemented.

A number of further features will now be described.

In one example, the instructions define module logic defining how modules interact, with the hub determining actions to be performed in accordance with the module logic. Thus, the module logic can specify how modules should be logically interconnected, in other words how the sensor data from one module can be used to control the actions implemented by another module.

Additionally and/or alternatively, the instructions can define actions associated with particular defined sensor readings, in which case, the hub processor 122 can operate to compare sensor data from a respective sensor module 111 to defined sensor readings and then determine the actions to be performed at least in part in accordance with the results of the comparison. For example, the instructions could define that an alarm is to be sounded if a temperature sensed by a temperature sensing module exceeds a defined temperature.

The hub 120 can also be adapted to store sensor data, allowing the sensor data to be subsequently utilised, for example, for review or logging purposes, as well as allowing historical data to be used in the event that current sensor data is not available. Accordingly, in one example, the hub processor 122 receives sensor data from a respective sensor module and then store the sensor data in a data store, such as a hub memory, together with an indication of the respective sensor module from which the sensor data was received. When reusing historical data as a replacement for live sensed data, the hub processor 122 will typically determine sensor data required from a respective sensor module using the instructions and determine if this sensor data is received within a defined time period. If this hasn't occurred, indicating live data is not available, in which case the hub processing 122 retrieves the most recent sensor data stored in the data store for that sensor module. This allows instructions to continue to be implemented even in the event that communication with a particular sensor module is lost or temporarily interrupted.

Whilst the hub 120 can control the performance of actions in a number of ways, typically the hub processor 122 determines the actions to be performed using the instructions and then generates control data in accordance with the actions to be performed. The control data can then be transferred to at least one action module or alternatively to an external device, such as a client device or remote server, allowing the relevant action module or external device to perform appropriate actions. Thus, it will be appreciated that the control data will typically specify the action required to be performed by the action module or external device, and provided any information required in order for this to occur. For example, if a message, such as an email or SMS is to be provided to a defined destination, an indication of the destination could be provided in the control data.

The hub processor 122 is typically adapted to perform instructions either based on instructions received from a client device, or based on instructions defined in a program stored in memory. This can include performing multiple sets of instructions in parallel, allowing multiple different processes to be performed substantially simultaneously.

Typically the hub processor 122 is adapted to maintain a list of available modules, allowing this to be used to assess whether particular programs or sets of instructions can be run, as well as to assist in generating instructions as previously described.

In one example, the list is maintained by having the hub processor 122 poll the nodes by providing a module request to each node 110, receive an indication of modules within each node in response to the module request and then maintain or update a list of available modules in accordance with the received indications. In one particular example, each wireless communication module can be adapted to receive the module request from the hub 120, broadcast the module request to each module within the node, receive a module response from each module and provide an indication of modules to the hub in accordance with the module responses. Thus, the hub processor 122 can broadcast requests to any available nodes without requiring specific information regarding the modules or nodes themselves. Similarly, the communications module of each mode will broadcast requests to each module within the node, receiving responses which are then passed back to the hub allowing the hub to collate a list of currently available modules.

In use, it is typical for the hub 120 to need to communicate with specific modules. Accordingly, each module within a node is typically associated with respective module address, whilst each node typically includes a node address, allowing the hub 120 and modules 111 to communicate using the respective node and module address. In one example, this information can be established when determining the module list, for example by having the module response from each module include a respective module address, and by having the communications modules provide a node address. Additionally and/or alternatively this can be performed by the hub, for example using suitable protocols, such an addressing protocol, similar to DHCP (Dynamic Host Configuration Protocol), or the like.

When communicating, the hub 120 can generate data packets including a header specifying a node and module address, with the data packet being transferred to the node communications module using the node address and then to the relevant module, using the module address. In this regard, modules can include a module processor that receives data packets, examines the header to determine if the data packet is addressed to the module and then process the data packet and/or forward the data packet to a next module in the node.

At least some of the modules also include a module memory that can be used to store module settings, allowing aspects of operation of the module to be controlled, and optionally other information such as sensor data or the like. The module settings can include a range of different setting such as sleep settings, communication settings, address settings, a sensor sampling frequency, status settings such as whether the module is busy, and actuator settings, as will be described in more detail below.

As previously mentioned, each node can include one or more power modules that supply electrical power to other modules in the node. It will be appreciated that these modules may be effectively “dumb” and have no interactivity, simply supplying power as needed. Alternatively, however, the power modules may have limited functionality, such as the ability to provide information regarding current power usage, remaining available power, or the like. The power units could be self-contained, and include replaceable/rechargeable power sources, such as batteries, solar panels, or other power sources, although alternatively the power supply could include a transformer for converting mains power into a lower voltage DC power supply.

Whilst a range of different sensors can be provided within sensor modules, examples include any one or more of an accelerometer, a light sensor, a microphone, a temperature sensor, or an input device that senses user inputs, such as keypad buttons or the like. However, it will be appreciated that these are only illustrative and that in practice any type of sensor that can be integrated into a module could be used.

One or more of the communications module can include a wireless communications module, although this is not essential and wired modules could be used. Whilst communications modules are typically used in conjunction with other modules to form a node, this is not essential and communications modules could also be used independently, for example to act as repeaters to extend the range of a communications link. This can also be performed whilst acting as a node communications module, allowing the hub to communicate with a node by transferring communications via intermediate nodes. Thus, it will be appreciated that the nodes can act as a distributed network, such as a mesh network or the like.

Similarly, the action module can include one or more of an output device that generates an output, a display that displays visual information, a switch that perpetuates an external device, such as a power switcher for controlling power supply to an appliance, or an actuator that performs a defined actuation, such as a servo motor, or the like.

As previously mentioned, as part of the process of creating instructions, the user can define module settings which are applied to the modules. This typically involves having the client device 130 determine module settings for at least one module in accordance with user input commands and provides an indication of the module settings to the hub, with the hub being responsive to the indication to update the module settings associated with the at least one module. By providing module settings as part of the instructions, this allows the hub to dynamically update module settings as part of the process of implementing the instructions, so that different settings could be used for different sets of instructions, with modules switching between different module settings as required. In one example, the module settings could also include a setting to preclude the module being used in other process, for example in the case that continuous uninterrupted data acquisition is needed.

When generating instructions, the client device typically determines actions to be performed in accordance with user input commands and generates the instructions in accordance with the actions. When the action is to be performed using an external device, this will typically involve having the user define actions, such as sending a notification in the form of an email, SMS or the like, using a particular server or device, allowing the hub to communicate with the server or device, so that the notification is generated in an appropriate manner. It will be appreciated that a range of different actions can be defined in a similar manner.

In order to allow users to create instruction sets in a logical and intuitive manner, the client device typically displays an interface including icons representing available modules, each icon representing a corresponding module or module type. The client device 130 can then position icons on the interface in accordance with user input commands, for example, allowing a user to drag and drop icons into position in a workspace. The client device 130 then displays connections between the icons in accordance with user input commands, allowing the user to draw connections between the icons corresponding to required logical connections between the modules in operation. The client device can then generate the instructions at least in part based on the connections between the icons. This allows the user to simply draw a logical arrangement of modules with instructions then being generated automatically based on this combination so that the user does not require any programing skills.

However, as an alternative, the client device could allowing instructions to be generated using a command line interface, for example, allowing a user to select a “script” icon in the web app, and then create a program by typing in commands, which are then sent to the hub and implemented. This process could also be performed without check for the presence of modules, just transferring commands to be hub, with these being implemented when modules become available.

The client device can also be adapted to generate a program including the instructions as opposed to simply forwarding instructions to the hub for immediate implementation. This allows the hub to operate in an autonomous manner independent of the client device. The program can also be provided to a remote data store, allowing this to then be accessed by other users in a manner similar to an application store (app store), or the like. In this scenario, the client device typically communicates with a remote data store to determine available programs, displays an indication of available programs, and determines a selected program in accordance with user input commands. At this point, the client device can compare available modules to a list of module requirements associated with the selected program and determine if any module requirements are not met, providing an indication of this to the user. Assuming the user wishes to proceed, the program can be downloaded to the client device and then transferred to the hub as required, with additional required modules being sourced as appropriate.

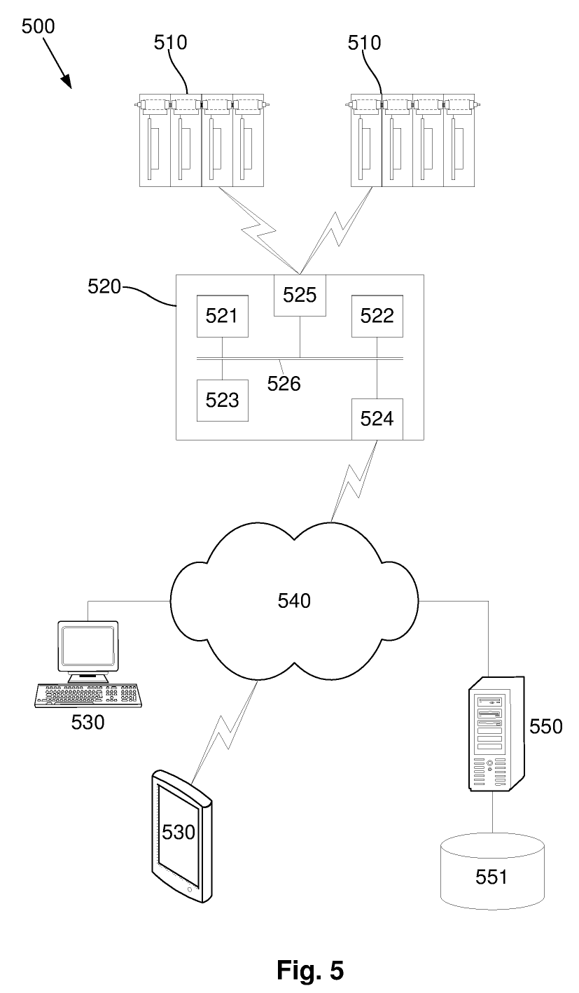

A further more detailed example of a modular electronics system will now be described with reference to FIG. 5.

In this example, the system 500 includes a number of nodes 510 each including respective modules 511 similar to the modules described above with respect to FIGS. 2A to 2C. The system further includes a hub 520 in communication with one or more client devices 530 and an optional server 550, via one or more communications networks 540.

The hub 520 includes a hub processor 521, a hub memory 522, an optional hub input/output device 523, such as a keyboard and display or touchscreen, an external interface 524 and a module interface 525 interconnected via a bus 526. The module interface 525 is adapted to wirelessly communicate with wireless communications modules of the hubs 511, whilst the client device interface 524 is adapted to allow communications with a client device 530 either directly, or via an intermediate communications network 540 as shown. Although a single external interface is shown, this is for the purpose of example only, and in practice multiple interfaces using various methods (eg. Ethernet, serial, USB, wireless or the like) may be provided. Similarly, the external interface 524 and module interface 525 could in fact be provided by a single interface, such as a wireless network interface, and reference to separate interfaces is not intended to be limiting.

In use, the hub processor 521 executes instructions in the form of applications software stored in the memory 522 to allow the modules to be controlled as required, for example allowing sensor data to be received from sensor modules and interpreted, with action data being generated to control actions performed by action modules or external devices. The applications software may include one or more software modules, and may be executed in a suitable execution environment, such as an operating system environment, or the like.

Accordingly, it will be appreciated that the hub 520 may be formed from any suitable processing system, such as a suitably programmed computer system, although this is not essential and the processing system could be any electronic processing device such as a microprocessor, microchip processor, logic gate configuration, firmware optionally associated with implementing logic such as an FPGA (Field Programmable Gate Array), or any other electronic device, system or arrangement.

In use, actions performed by the hub 520 are performed by the hub processor 521 in accordance with instructions stored as applications software in the memory 522 and/or input commands received from a user via the I/O device 523, or commands received from the client device 530.

The communications network 540 can be of any appropriate form, such as the Internet and/or a number of local area networks (LANs) 204 and provides onward connectivity to one or more client devices 530 and the server 550, which is in turn coupled to a database 551. It will be appreciated that this configuration is for the purpose of example only, and in practice the hub 520, client devices 530 and servers 550 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In one example, each server 550 is adapted to provide hosting and access to applications, whilst client devices 530 are used for generating instructions, including applications. Whilst the server 550 is a shown as a single entity, it will be appreciated that the server 550 can be distributed over a number of geographically separate locations, for example by using processing systems and/or databases 551 that are provided as part of a cloud based environment. However, the above described arrangement is not essential and other suitable configurations could be used.

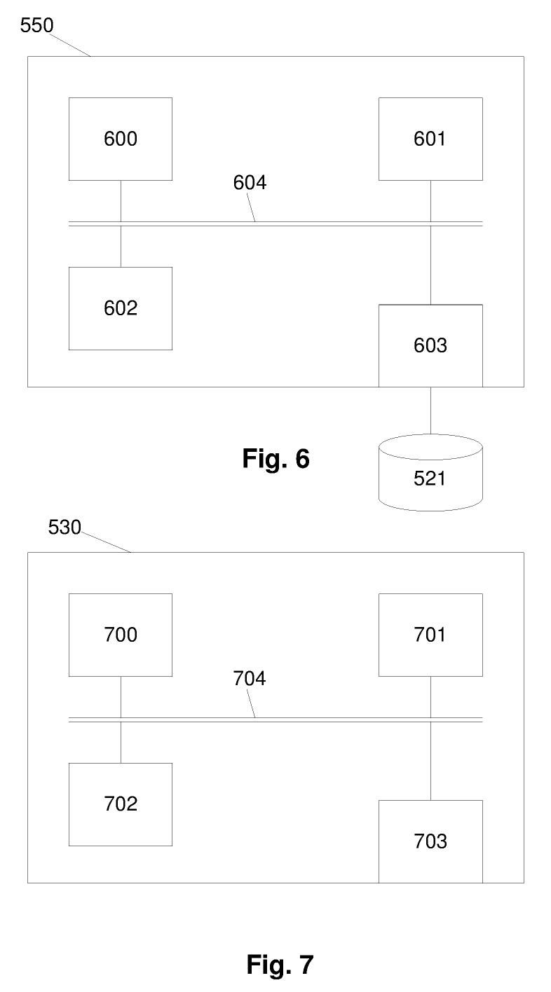

An example of a suitable server 550 is shown in FIG. 6. In this example, the server includes at least one microprocessor 600, a memory 601, an optional input/output device 602, such as a keyboard and/or display, and an external interface 603, interconnected via a bus 604 as shown. In this example the external interface 603 can be utilised for connecting the server 550 to peripheral devices, such as the communications networks 540, databases 511, other storage devices, or the like. Although a single external interface 603 is shown, this is for the purpose of example only, and in practice multiple interfaces using various methods (eg. Ethernet, serial, USB, wireless or the like) may be provided.

In use, the microprocessor 600 executes instructions in the form of applications software stored in the memory 601 to allow the required processes to be performed, including communicating with the client devices, generating webpages for example including the designer interface, generating instruction sets and/or programs, or the like. The applications software may include one or more software modules, and may be executed in a suitable execution environment, such as an operating system environment, or the like.

Accordingly, it will be appreciated that the server 550 may be formed from any suitable processing system, such as a suitably programmed client device, PC, web server, network server, or the like. In one particular example, the server 550 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

As shown in FIG. 7, in one example, the client device 530 includes at least one microprocessor 700, a memory 701, an input/output device 702, such as a keyboard and/or display, and an external interface 703, interconnected via a bus 704 as shown. In this example the external interface 703 can be utilised for connecting the client device 530 to peripheral devices, such as the communications networks 450, databases, other storage devices, or the like. Although a single external interface 703 is shown, this is for the purpose of example only, and in practice multiple interfaces using various methods (eg. Ethernet, serial, USB, wireless or the like) may be provided.

In use, the microprocessor 700 executes instructions in the form of applications software stored in the memory 701 to allow communication with the hub 520 or server 550, for example to allow for creation and implementation of instructions, to display designer interfaces or the like.

Accordingly, it will be appreciated that the client devices 530 may be formed from any suitable processing system, such as a suitably programmed PC, Internet terminal, lap-top, or hand-held PC, and in one preferred example is either a tablet, or smart phone, or the like. Thus, in one example, the client device 530 is a standard processing system such as an Intel Architecture based processing system, which executes software applications stored on non-volatile (e.g., hard disk) storage, although this is not essential. However, it will also be understood that the client devices 530 can be any electronic processing device such as a microprocessor, microchip processor, logic gate configuration, firmware optionally associated with implementing logic such as an FPGA (Field Programmable Gate Array), or any other electronic device, system or arrangement.

Examples of the operation of the modular electronics system will now be described in further detail. For the purpose of these examples it will also be assumed that the user interacts with the client device 530 via a GUI (Graphical User Interface), or the like presented on the client device 530, which may be generated by a local application, or hosted by the server 550 and displayed via a suitable application, such as a browser or the like, executed by the client device 530. Actions performed by the client device 530 are typically performed by the processor 700 in accordance with instructions stored as applications software in the memory 701 and/or input commands received from a user via the I/O device 702. Similarly, actions performed by the server 550 are performed by the processor 600 in accordance with instructions stored as applications software in the memory 601 and/or input commands received from a user via the I/O device 602, or commands received from the client device 530.

However, it will be appreciated that the above described configuration assumed for the purpose of the following examples is not essential, and numerous other configurations may be used. It will also be appreciated that the partitioning of functionality between the hub 520, client devices 530, and servers 550 may vary, depending on the particular implementation.

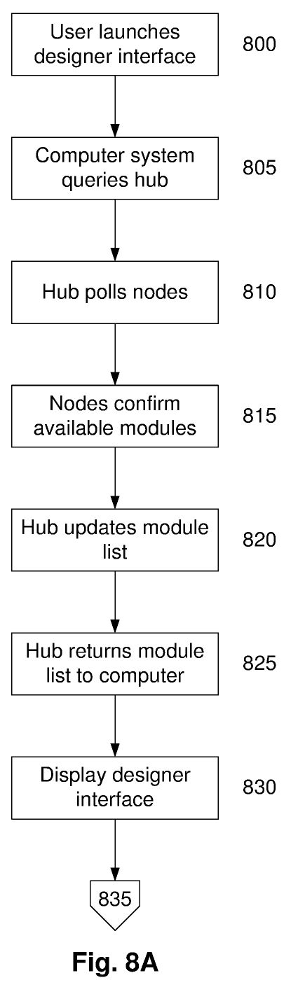

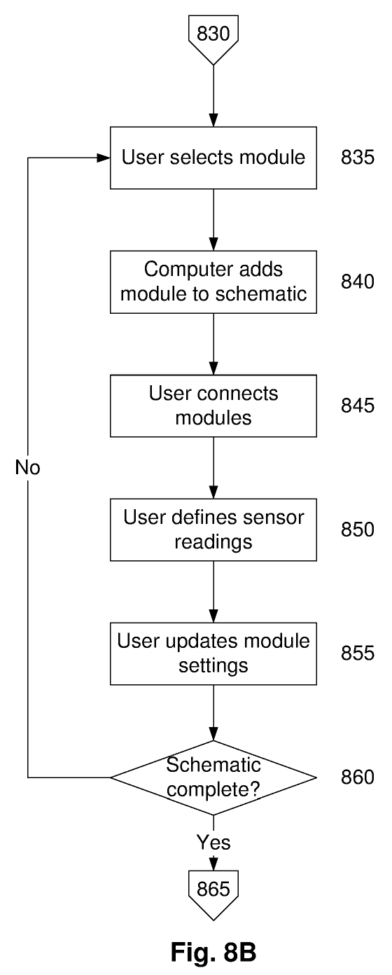

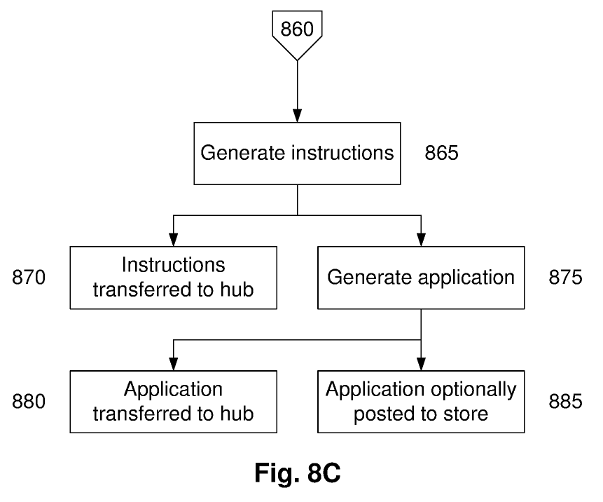

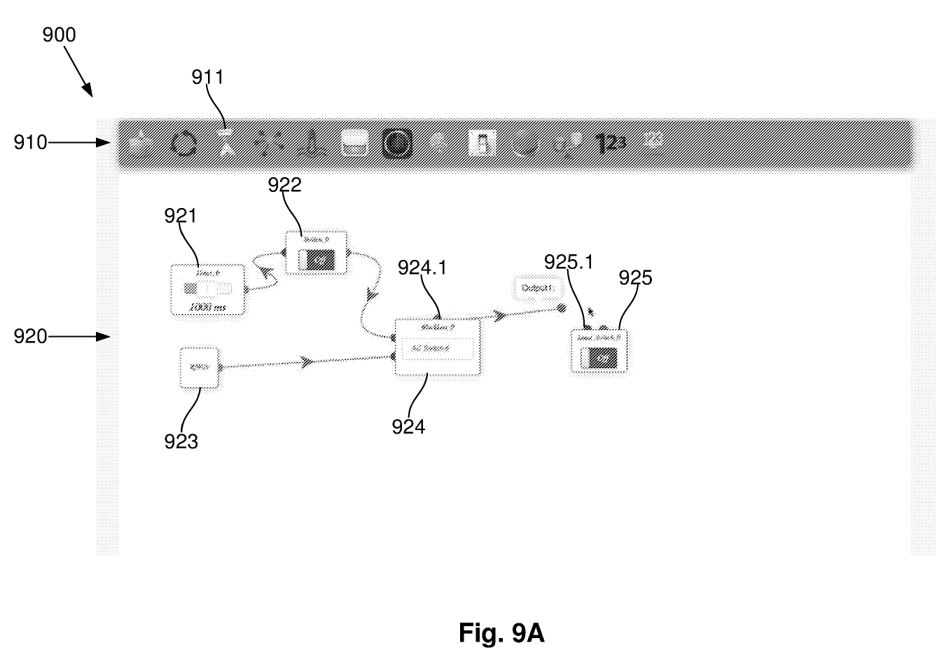

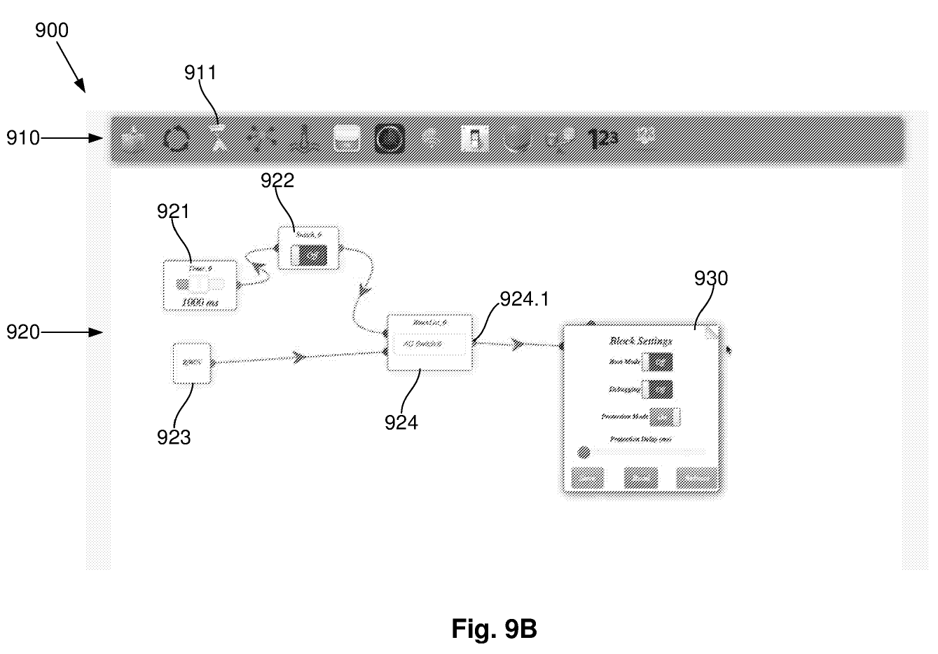

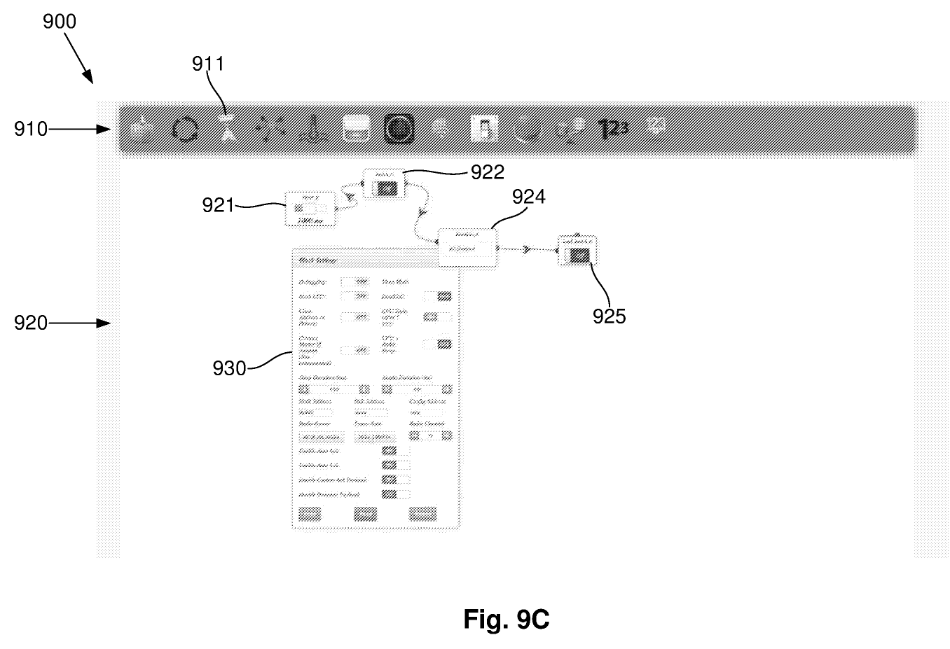

An example of the process for creating instructions will now be described with reference to FIG. 8A to 8C and FIGS. 9A to 9C.

In this example, the user utilises a client device 530 to select an option to launch a design interface, for example by opening respective design software or selecting an option on a webpage or the like hosted by the server 550.

At step 805 the client device 530 queries the hub 520 to determine a list of available modules. The hub 520 can simply return a list of modules stored in the hub memory 522 or alternatively can retrieve information in real-time by polling the each of the nodes 510, at step 810. In this case, the communications module of each node will receive a module request from the hub and transfer the module request to each of the modules 511 within the node 510. The modules 511 in each node 510 provide a module response, which is then consolidated by the communications module 511, which in turn returns an indication of the available modules to the hub 520 at step 815. The hub 520 updates the module list at step 820, providing an indication of the module list to the client device 530, at step 825.

The client device 530 then displays the designer interface, an example of which is shown in FIG. 9A. In particular, the interface 900 includes a tool bar 910 and workspace 920. The toolbar 910 includes a number of icons 911, each of which is indicative of a respective available module 511, whilst the workspace 920 is initially empty. It will be appreciated that additional information, such as the function of any modules could be displayed, for example using an appropriate input command, such as hovering a pointer over an icon, or the like. The icons could also be indicative of actions that can be performed by external devices, allowing the user to integrate these into the module logic as a virtual module.

At step 835 the user utilises the designer interface to select a module of interest, dragging and dropping the module into the workspace 920 thereby causing the client device 530 to add the module to the workspace 920, as shown for example by the icons 921, 922, 923, 924, 925. At step 845 the user creates connections between the modules for example by dragging a connection from a module output 924.1 to a module input 925.1 of another module. The user can then also define any relevant sensor readings at step 850, for example that are used to trigger actions that are to be performed, such as actuating an action module, or triggering an external action based on a virtual action module.

Furthermore, utilising an appropriate input command, such as a right click, the user can view module parameters by having the client device 530 display a dialogue box 930 in the workspace 920 as shown in FIGS. 9B and 9C. This allows the user to optionally update module settings at step 855, for example to define aspects of module operation or the like. It is then determined if the schematic is complete at step 860 and if not the process returns to step 835 allowing the user to add further modules.

Accordingly, it will be appreciated that the above described system allows the user to progressively add modules and interconnect these to define modular logic providing respective functionality. Additionally, the user can define module settings, defining how the module is to operate, and also define sensor readings used to trigger the operation of action modules, either in the form of physical action modules, or virtual action modules corresponding to actions that can be performed by external devices.

Once completed, the client device 530 generates instructions at step 865 embodying the modular logic and defined module settings, sensor readings or the like. The instructions can then be transferred to the hub 520 at step 870, for example in the form of individual commands, which the hub 520 then implements. Alternatively, the instructions could be used to generate an application at step 875, in the form of a complied application, which can then either by transferred to the hub 520 at step 880 for subsequent execution and/or optionally posted to an application store, for example by transferring the application to a remote server 550 at step 885.

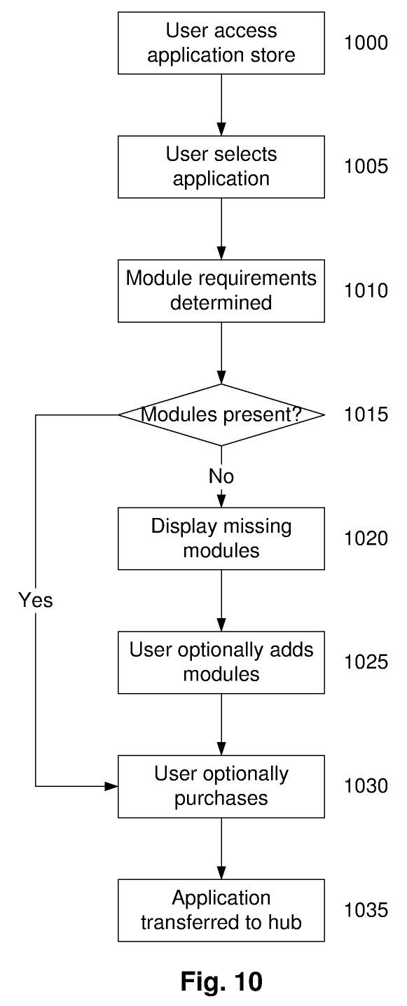

The ability to provide applications to a store allows users to share applications, making these available to other users for download to their own hub 520. An example of this process will now be described with reference to FIG. 10.

In this example, at step 1000 the user accesses an application store hosted by the server 550. The user selects an application at step 1005 with the client device 530 operating to determine module requirements associated with the application at step 1010, for example based on information provided by the server 550.

At step 1015, the client device 530 determines if required modules are present, for example by querying the hub using the process described above with respect to steps 805 to 825.

If it is determined that required modules are not present, the client device 530 can display an indication of the missing modules at step 1020 allowing the user to optionally add modules at step 1025. For example, the user could be provided with a link allowing them to order the modules from a module supplier.

At step 1030, if it is determined that all modules are present, once modules have been obtained, or otherwise if the user proceeds without modules in place, the user can choose to acquire the application. In one example, the application could be made available free of charge. However, alternatively the applications could be bought and sold, in which case a purchasing process may need to be performed, with a proportion of any costs being allocated to the application creator in accordance with standard store processes, as will be appreciated by persons skilled in the art.

Once acquired, the application can be retrieved from the remote server 550 and transferred to the hub 520 at step 1035, allowing this to be implemented by the hub.

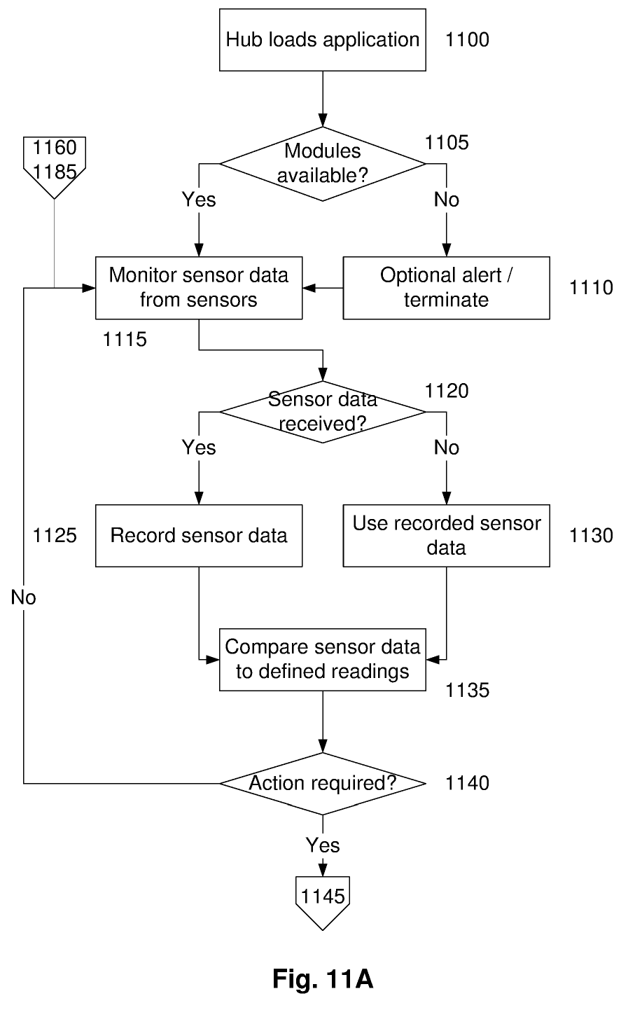

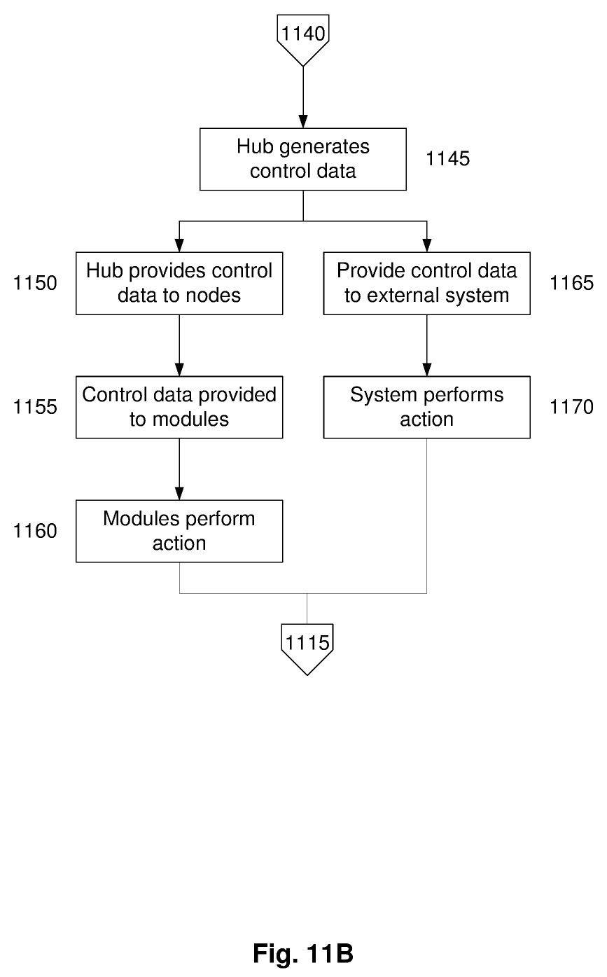

An example of the process for implementing an application will now be described with reference to FIGS. 11A and 11B.

In this example, at step 1100 the hub 520 loads an application, for example by having the hub processor 521 retrieve the application from memory 522, and determine if relevant modules are available at step 1105. If modules are not available an optional alert can be generated at step 1110 or alternatively the process can be terminated or simply continue to the extent it can in absence of the relevant modules.

Otherwise, at step 1115 the hub processor 521 operates to monitor sensor data from the sensor modules identified within the application. At step 1120 the hub processor 521 determines if required sensor data has been received and if so operates to record the sensor data in the hub memory 522 at step 1125. If relevant sensor data has not been received, previously recorded sensor data is retrieved at step 1130.

In either case, at step 1135 sensor data is compared to defined sensor readings specified in the instructions, to determine if action is required at step 1140. If no action is required, the process simply returns to step 1115 allowing ongoing monitoring of sensor data from the sensors. Otherwise, at step 1145 the hub generates control data indicative of the action to be performed. The action is specified in the instructions together with an indication of the control data and control data destination, either in the form of a physical action module, or a virtual action module in the form of an external device.

The hub 520 then either provides the control data to a node at step 1150, with the control data being passed on to a respective control module at step 1155, which then performs relevant actions at step 1160, or by providing the control data to an external system such as a server 550, which can then perform relevant actions at step 1170.

Accordingly, the above described system allows respective functionality to be performed by the modules.

Accordingly, the above described system provides a solution that allows individuals without specific studies in software or hardware development to build complex electronic systems using a combination of modules, overseen by a controlling hub, which can also be used to provide onward connectivity to remote systems, such as cloud based systems. Operation of the system is controlled using instructions, that can be generated using an intuitive graphical based interface, allowing individuals with no programming experience to create applications to provide a wide range of different functionality. These applications can then be published to an application store, allowing these to be shared, purchased or sold to other users.

The above described system uses individual modules that couple together magnetically, allowing different devices to snap together in any order to form individual nodes, with the behaviour of the nodes and modules being controlled by software operating on the hub. This allows users to rapidly configure and test particular combinations of modules to ensure they achieve the desired functionality.

In one particular example, the modules use a four pin connector to transfer both data and power. The modules snap together though two magnets positioned in adjacent sides of the connector. Each individual module or “Block” contains one or multiple electronic sensors inside (accelerometer, temperature sensor, pressure sensor, etc) and it is in charge of performing one predetermined function (measuring movement, temperature, provide power). When two or more blocks are snapped together, the group of blocks becomes a “Node”, creating a local wired network in order to communicate with each other. At a given time, one block becomes the master of the network and is allowed to query the other blocks for data. Each new block added to the group expands the capability of the Node, for instance, if a radio block is connected, the Node acquires the ability to transfer data wirelessly, similarly, if an IR Block (infrared Block) is added, the Node is then able to send and detect infrared signals so that it can be used to communicate with other devices such as TVs, Aircons, etc.

Nodes don't communicate to each other, but instead communicate via the Hub, which sends and receives data to and from each Node wirelessly via a Radio Block (RF Block). In the Hub, multiple software applications can run simultaneously collecting data and sending instructions in real time to the remote Nodes in order to perform a particular task. For instance, sending an SMS alert if the Temperature measured by a remote block is higher than a given threshold.

Accordingly, this arrangement allows people can use to build their own devices easily, additionally allowing them to reuse modules as part of multiple different applications, thereby increasing the functionality that can be provided given a particular set of hardware. Thus, unlike traditional systems in which a single device is used to solve one particular problem; for instance a smoke detector, a light switch, a toaster, the current system provides individual modules that interact with each other. This allows users to either replace the parts of the devices they feel are not working properly or just want to upgrade (similarly to the RAM memory or hard drive in a computer) or simply build a complete new device from the parts of the old one.

Since each block is magnetic coupled and electrically interconnected using respective contacts, the modules can communicate through a digital protocol, with operation being coordinated by the hub. As a result, a user doesn't need specialised tools, complex understanding of the technology, or even connecting them in a particular order; they just need to “snap” all the blocks required to build the new device. In addition, there will be an App Store, where users can download pre-built applications for new devices, for instance, an app to automate all the lights at home, or an app that uses movement sensors to detect intruders when the user is not at home, etc.

In this regard, if a user wants build a new device found in the app store, the system will automatically detect if they have all the blocks required, and if they don't, it can suggest to automatically ship the missing blocks directly to their home address.

The system also provides an interface in the form of a web application, allowing users who don't know how to code, to build complex apps just by dragging and dropping icons representing blocks, without writing a single line of code.

This technology can be used in multiple target markets, and example usage scenarios include, but aren't limited to:
Schools, by creating educational projects to teach students to program, or play with robots.
An extremely cheap alternative to the existing Home Automation technologies.
As security devices.
As prototyping modules for hobbyist or electronic students.

Additionally, the use of FCC certified communication modules allows individuals wanting to sell a new technology that uses wireless communications to use the wireless communications modules described herein to avoid the need to perform independent certifications or lab testing, assuming their own system is compatible with the communications module.

A number of practical example usage scenarios will now be described.

### Room Controller

For example, in a person may wish to to be able to control the lights of a living room, they gather 2 blocks, a Radio Block and an AC switch block, and by snapping them together this person is then able to remotely turn ON and OFF any device connected to the AC switch Block. If for example rather than controlling the state of the light manually the user wants to turn them On when someone arrives at home, they just need to add a Movement Sensor Block to the existing Node. Just by updating the code of the application running on the Hub, this person can now make the lights turn on and off if the movement sensor detects the presence of a person entering the room.

### Gaming Peripheral

The purpose of this device is to provide an input control for a computer game, such as steering the wheel of a vehicle. In this example, this is achieved by physically moving node, and detecting movement of the node. This could be achieved for example by attaching the node to a physical object, such as a plate, or the like, which can then be rotated to mimic the action of the steering wheel.

In this example, required modules include:
A radio communication module;
A gyroscope sensor module; and,
A battery module.

The designer interface uses the following icons/apps:
Node Identifier: Identifies a node in the network
Module list: Returns the list of modules connected to a node
Timer: Request other apps to execute whatever actions they were programmed to do every X period of time (ms).
Gyro Controller: Retrieves data from a “Gyroscope Module”
Keyboard Simulator: Sends commands to the OS to simulate a “key pressed” event

The client device implementing the designer interface is constantly requesting the hub (using the timer) to retrieve data from the gyroscope module, measuring the angle in which the users rotates the node, this value is stored in memory and then a signal is sent to the Keyboard Simulator to “press” the key associated in the game to move the virtual Vehicle Left or Right. With this basic logic, users can create a device that simulates an Analog Racing Wheel.

### Thermostat

This is a home automation application that controls the temperature of a home based on a user pre-defined settings.

In this example, required modules include:
A radio communications module;
An IR (infrared) module;
A temperature module (temperature sensor); and,
Battery Module (or any other module that provides power)

The designer interface uses the following icons/apps:
Node Identifier: Identifies a node in the network
Module list: Returns the list of modules connected to a node
Timer: Request other apps to execute whatever actions they were programmed to do every X period of time (ms).
IR Controller: Receives and Sends infrared signals through an IR Module
Temperature Controller: Reads temperature data from a Temperature Module
Comparator: Compares 2 values
Value: Stores numeric values

The application uses the timer to constantly request the temperature from the temperature module, with the value returned being compared against a predefined value using the comparator. If the current temperature is above or below the threshold stored in Value, a signal is sent via the IR controller to the home Air Conditioner Unit to increase or reduce the temperature. In this way, an user can easily maintain a constant temperature at home. It should be noted in this regard that the IR commands required to operate a home appliance such as an Aircon (or TV, Blu-ray, Sound Bar, etc) must be programmed into the controller, for example by recording these from the original remote control of the device.

### Internet Connected Doorbell

The purpose of this application is to alert the user (even when they are not at home) if someone is at their front door.

In this example, required modules include:
A radio communications module;
A solar power module; and,
A input button module.

The designer interface uses the following icons/apps:
Node Identifier: Identifies a node in the network
Module list: Returns the list of modules connected to a node
Button Controller: Gets activated when a remote button is pressed or released.
SMS Controller: Sends an SMS message to a predefined phone number.

For this application an event driven approach is used, so the button controller's settings are changed to send a signal to the hub when its button is pressed, rather than checking constantly if the button was actioned. The use of a solar power module means batteries aren't required in order for this to function.

In this instance, when a person arrives at the door and presses the button of the button module, a signal is sent to the hub which then informs the app about this action, the SMS controller which is connected to the button controller is then ‘called’ to send an SMS to the predefined number, notifying the user through their mobile phone. It should be noted that another way to implement this device is to use an accelerometer rather than a button module, so that the app can sense (by measuring the vibrations) when someone actually “knocks” on the door. Users could also use a “Sound Controller” to play the sound of a doorbell through the speakers of their computer.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A modular electronics system including:
a) at least one node including a plurality of interconnected modules, each module including:
i) a housing;
ii) physical connectors that physically interconnect the modules;
iii) electrical connectors that electrically interconnect the modules, the electrical connectors including data and power connectors; and,
iv) electronic components that provide respective functionality, wherein each node includes:
(1) at least one communications module; and,
(2) at least one of:
(a) a sensor module including at least one sensor that generates sensor data indicative of one or more sensed conditions; and,
(b) an action module that performs one or more actions in accordance with received control data; and,
b) a hub including:
i) a module interface that communicates with the at least one communications module of each node;
ii) a hub processor that, in accordance with defined instructions:
(1) monitors sensor data provided by at least one sensor module;
(2) determines at least one action to be performed at least partially in accordance with the sensor data; and,
(3) causes the at least one action to be performed by at least one of:
(a) at least one action module; and,
(b) an external device.

2. A modular electronics system according to claim 1, wherein the instructions define at least one of:
a) module logic defining how modules interact, and wherein the hub determines actions in accordance with the module logic; and
b) actions associated with defined sensor readings, and wherein the hub processor:
i) compares sensor data from a respective sensor module to defined sensor readings; and,
ii) determines the actions at least in part in accordance with the results of the comparison.

3. (canceled)

4. A modular electronics system according to claim 1, wherein the hub processor:
a) receives sensor data from a respective sensor module; and,
b) stores the sensor data in a data store together with an indication of the respective sensor module.

5. A modular electronics system according to claim 4, wherein the hub processor:
a) determines sensor data required from a respective sensor module using the instructions;
b) determines if sensor data from the respective sensor module is received within a defined time period; and,
c) if sensor data is not received during the defined time period, retrieves sensor data from the data store.

6. A modular electronics system according to claim 1, wherein the hub processor:
a) determines the actions to be performed at least in part using the instructions;
b) generates control data in accordance with the actions to be performed; and,
c) transfers the control data, to at least one of:
i) at least one action module; and,
ii) an external device.

7. A modular electronics system according to claim 1, wherein the hub includes a hub memory that stores a program defining the instructions.

8. A modular electronics system according to claim 1, wherein the hub processor at least one of:
a) performs instructions received from a client device;
b) performs instructions defined by a program stored in memory; and,
c) performs multiple sets of instructions substantially simultaneously.

9. A modular electronics system according to claim 1, wherein the hub processor:
a) provides a module request to each node;
b) receives an indication of modules within each node in response to the module request; and,
c) maintains a list of available modules in accordance with received indications of modules.

10. A modular electronics system according to claim 9, wherein the communications module:
a) receives the module request;
b) broadcasts the module request to each module within the node;
c) receives a module response from each module; and,
d) provides an indication of modules to the hub in accordance with the module responses.

11. A modular electronics system according to claim 1, wherein at least some of the modules include at least one of:
a) a module processor that communicates with the hub via the communications module; and
b) a module memory that stores module settings, the module operating in accordance with module settings.

12. (canceled)

13. A modular electronics system according to claim 11, wherein the module settings include at least one of:
a) sleep settings;
b) communication settings;
c) address settings;
d) a sensor sampling frequency;
e) status settings; and,
f) actuator settings.

14. A modular electronics system according to claim 1, wherein at least one of:
a) each communications module is associated with a respective node address and wherein the hub communicates with the node using the respective node address; and
b) a module within a node is associated with a respective module address and wherein the hub and modules within a node communicate using the respective module address.

15. (canceled)

16. A modular electronics system according to claim 1, wherein at least one of:
a) each node includes at least one power module that supplies electrical power to other modules in the node; and
b) the at least one communications module includes a wireless communication module.

17. A modular electronics system according to claim 1, wherein the action module includes at least one of:
a) an output device that generates an output;
b) a display that displays visual information;
c) a switch that actuates an external device; and,
d) an actuator that performs a defined actuation.

18. A modular electronics system according to claim 1, wherein at least one sensor module includes at least one of:
a) an accelerometer;
b) a light sensor;
c) a microphone;
d) a temperature sensor; and,
e) an input device that senses user inputs.

19. (canceled)

20. A modular electronics system according to any one of the claim 1, wherein the system includes a client device having:
a) a display;
b) an input device;
c) a memory storing applications software; and,
d) an electronic processing device that operates in accordance with the applications software to:
i) determine a module logic corresponding to interaction between selected ones of the modules in accordance with user input commands;
ii) generate instructions in accordance with the module logic; and,
iii) provide the instructions to the hub, the hub responsive to the instructions to control the modules.

21. A modular electronics system according to claim 20, wherein the client device at least one of: communicates with the hub to determine available modules, the available modules forming part of nodes in communication with the hub and
a) displays an indication of available modules;
b) determines module settings for at least one module in accordance with user input commands and provides an indication of the module settings to the hub, the hub being responsive to the indication to update module settings associated with the at least one module; and,
c) determines actions to be performed by external devices in accordance with user input commands and generates the instructions in accordance with the actions.

22. (canceled)

23. (canceled)

24. A modular electronics system according to claim 20, wherein the client device:
a) displays an interface including icons representing available modules, each icon representing a corresponding module;
b) positions icons on the interface in accordance with user input commands;
c) displays connections between the icons in accordance with user input commands; and,
d) generates the instructions at least in part based on the connections between the icons.

25. A modular electronics system according to claim 24, wherein the client device:
a) determines a user selected icon in accordance with user input commands;
b) determines module settings associated with the corresponding module;
c) displays an indication of the module settings;
d) determines modified module settings in accordance with user input commands; and,
e) provides an indication of the modified module settings to the hub, the hub being response to update module settings for the corresponding module.

26. A modular electronics system according to claim 20, wherein the client device:
a) generates a program including the instructions; and,
b) provides the program to at least one of:
i) the hub; and,
ii) a data store.

27. A modular electronics system according to claim 20, wherein the client device:
a) communicates with a data store to determine available programs;
b) displays an indication of available programs;
c) determines a selected program in accordance with user input commands;
d) compares available modules to a list of module requirements associated with the selected program;
e) determines if any module requirements are not met; and,
f) provides an indication of any unmet module requirements to the user.

28. A modular electronics system according to claim 1, wherein the physical connectors include magnets.

29. A client device for controlling a modular electronics system, the modular electronics system having at least one node including a plurality of interconnected modules and a hub that communicates with the modules, the client device having:
a) a display;
b) an input device;
c) a memory storing applications software; and,
d) an electronic processing device that operates in accordance with the applications software to:
i) communicate with the hub to determine available modules, the available modules forming part of nodes in communication with the hub;
ii) display an indication of available modules;
iii) determine a module logic corresponding to interaction between selected ones of the modules in accordance with user input commands, at least one of:
iv) generate instructions in accordance with the module logic; and,
v) provide the instructions to the hub, the hub responsive to the instructions to control the modules.
